(19) United States
(12) Patent Application Publication
(10) Pub. No.: US 2022/0269350 A1
(43) Pub. Date: Aug. 25, 2022

(54) Detection and Classification of Unknown Motions in Wearable Devices

(71) Applicant: Google LLC, Mountain View, CA (US)

(72) Inventors: Nicholas Gillian, Palo Alto, CA (US); Daniel Lee Giles, Fremont, CA (US)

(21) Appl. No.: 17/631,788

(22) PCT Filed: Jul. 30, 2020
(86) PCT No.: PCT/US2020/044182

§ 371 Date: Jan. 31, 2022

Related U.S. Application Data
(60) Provisional application No. 62/880,634, filed on Jul. 30, 2019.

(51) Int. Cl. G06F 3/01; G06N 3/02; G06F 1/16; D03D 15/533; D03D 15/25; D03D 1/00

(52) U.S. Cl. CPC G06F 3/017; G06N 3/02; G06F 1/163; D03D 15/533; D03D 15/25; D03D 1/0088; D10B 2401/16; D10B 2401/18; D10B 2101/20

(57) ABSTRACT

Computing systems and related methods are provided for discovery of undefined user movements. Sensor data associated with one or more sensors of a wearable device can be obtained and input into one or more machine-learned models that have been trained to learn a continuous embedding space based at least in part on one or more target criteria. Data indicative of a position of the sensor data within the continuous embedding space can be obtained as an output of the one or more machine-learned models. A functionality associated with the position of the sensor data within the continuous embedding space can be determined. The functionality associated with the position of the sensor data within the continuous embedding space can be initiated.

### CROSS-REFERENCE TO RELATED APPLICATIONS

This application is based upon and claims the right of priority to U.S. Provisional Application No. 62/880,634, filed Jul. 30, 2019, and entitled “Detection and Classification of Unknown Motions in Wearable Devices,” the disclosure of which is hereby incorporated by reference herein in its entirety for all purposes.

### FIELD

The present disclosure relates generally to machine-learned models for generating inferences based on sensor data.

### BACKGROUND

Detecting gestures and other motions using wearables and other devices that may include computing devices with limited computational resources (e.g., processing capabilities, memory, etc.) can present a number of unique considerations. Machine-learned models are often used as part of gesture detection and movement recognition processes that are based on input sensor data. Sensor data such as touch data generated in response to touch input, or motion data generated in response to user motion, can be input to one or more machine-learned models. The machine-learned models can be trained to generate one or more inferences based on the input sensor data. These inferences can include detections, classifications, and/or predictions of gestures and/or movements. By way of example, a machine-learned model may be used to determine if input sensor data corresponds to a swipe gesture or other intended user input.

Traditionally, computing systems have been pre-configured to detect specific activities, motions, and/or interactions that product designers determine a product such as a wearable device should be able to detect. For example, a computing system may be pre-configured to detect a number of predefined gestures in response to user input detected by a touch sensor. The predefined gestures can be defined (e.g., by a product designer) and then one or more algorithms can be designed (e.g., by an engineering team) that are capable of recognizing the pre-defined gestures. For instance, one or more machine-learned models can be trained using sensor data that has been collected and annotated to indicate the corresponding gesture to which it corresponds.

While such approaches that utilize pre-defined movements may be effective in some instances, they may have several notable drawbacks. In order to design an algorithm to detect a specific activity, motion, or interaction, the specific activity, motion, or interaction must be defined before a product is released. Among other things, this approach may not enable the computing system to detect, classify, or otherwise analyze movements that are not defined prior to the product release. For instance, a new motion created by a user may not be capable of detection, classification, and/or analysis by the computing system. Moreover, a new motion by a user may not be capable of comparison with other motions, such as those performed by other users.

### SUMMARY

Aspects and advantages of embodiments of the present disclosure will be set forth in part in the following description, or may be learned from the description, or may be learned through practice of the embodiments.

One example aspect of the present disclosure is directed to a computing system, comprising one or more processors one or more non-transitory computer-readable media that collectively store instructions that when executed by the one or more processors cause the one or more processors to perform operations. The operations include obtaining sensor data associated with one or more sensors of a wearable device, inputting the sensor data into one or more machine-learned models that have been trained, based at least in part on one or more target criteria, to determine a position of the sensor data within a continuous embedding space, obtaining as an output of the one or more machine-learned models, data indicative of the position of the sensor data within the continuous embedding space, determining a functionality associated with the position of the sensor data within the continuous embedding space, and initiating the functionality associated with the position of the sensor data within the continuous embedding space.

Another example aspect of the present disclosure is directed to a computer-implemented method for discovery of undefined user movements. The method can include obtaining, by one or more processors, sensor data associated with one or more sensors of a wearable device, inputting, by the one or more processors, the sensor data into one or more machine-learned models that have been trained, based at least in part on one or more target criteria, to determine a position of the sensor data within a continuous embedding space, obtaining, by the one or more processors, as an output of the one or more machine-learned models, data indicative of the position of the sensor data within the continuous embedding space, determining, by the one or more processors, a functionality associated with the position of the sensor data within the continuous embedding space, and initiating, by the one or more processors, the functionality associated with the position of the sensor data within the continuous embedding space.

Yet another example aspect of the present disclosure is directed to one or more non-transitory computer-readable media storing computer instructions, that when executed by one or more processors, cause the one or more processors to perform operations. The operations include obtaining data descriptive of one or more machine-learned models, obtaining data descriptive of one or more target criteria for a continuous embedding space of the one or more machine-learned models, providing one or more sets of training data as input to the one or more machine-learned models, obtaining, as output of the one or more machine-learned models, data indicative of a position of the one or more sets of training data within the continuous embedding space, determining one or more loss function parameters based at least in part of the one or more target criteria and the data indicative of the position of the one or more sets of training data within the continuous embedding space, and modifying at least a portion of the one or more machine-learned models based at least in part on the one or more loss function parameters.

Other example aspects of the present disclosure are directed to systems, apparatus, computer program products (such as tangible, non-transitory computer-readable media but also such as software which is downloadable over a communications network without necessarily being stored in non-transitory form), user interfaces, memory devices, and electronic devices for detecting previously undefined user movements associated with wearable devices.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example computing environment in which a machine-learned model in accordance with example embodiments of the present disclosure may be implemented;

FIG. 2 depicts a block diagram of an example computing environment that includes an interactive object in accordance with example embodiments of the present disclosure;

FIG. 3 depicts an example of a touch sensor in accordance with example embodiments of the present disclosure;

FIG. 4 depicts an example of a computing environment and the detection of a previously undefined user movement in accordance with example embodiments of the present disclosure;

FIG. 5 depicts a flowchart describing an example method in accordance with example embodiments of the present disclosure;

FIG. 6 depicts a flowchart describing an example method in accordance with example embodiments of the present disclosure;

FIG. 7 depicts a flowchart describing an example method in accordance with example embodiments of the present disclosure;

FIG. 8 depicts a flowchart describing an example method in accordance with example embodiments of the present disclosure;

FIG. 9 depicts a block diagram of an example computing system for training and deploying a machine-learned model in accordance with example embodiments of the present disclosure;

FIG. 10 depicts a block diagram of an example computing device that can be used to implement example embodiments in accordance with the present disclosure; and

FIG. 11 depicts a block diagram of an example computing device that can be used to implement example embodiments in accordance with the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed to computing systems that include machine-learned models for detecting and classifying previously undefined user movements, such as user movements detected in response to sensor data generated by wearable computing devices. More particularly, a machine-learned system is provided that includes one or more machine-learned models that are configured to automatically group sensor data based on one or more predefined criteria so that undefined movements can be compared and analyzed within a continuous embedding space. For example, sensor data may be received by a computing system in response to a user performing a new movement that is undefined relative to the computing system. The new movement may include a new trick while playing a sport, a new move while performing a dance, a new interaction while working, or any other new movement. Sensor data can be generated by one or more sensors of a wearable interactive object in association with the new movement. The new movement performed by the user may be previously undefined or otherwise unknown to the computing system prior to its performance by the user. The one or more machine-learned models can be trained to generate a position of the new movement within a learned, continuous embedding space. In this manner, the machine-learned system can provide data indicative of a position of undefined movements within the continuous embedding space. The position data for a new movement may include data indicative of one or more motion categorizations, data indicative of levels associated with the motion categorizations, and/or data indicative of scores or other representations of attributes associated with the movement. In this manner, the machine-learned system can group sensor data based on criteria so that new movements can be compared and analyzed within a common embedding space.

According to some aspects of the disclosed technology, one or more machine-learned models can be trained to learn a continuous embedding space in which activities, motions, and/or interactions can be automatically grouped based on a number of predefined criteria. In this manner, sensor data indicative of unknown activities, motions, and/or interactions performed by a user can be accessed and projected into the learned continuous embedding space to determine a position or other signature for the sensor data in the learned continuous embedding space. The position of the sensor data in the continuous embedding space can be analyzed to initiate functionalities at a computing device. By way of example, gaming elements such as features, characters, options, levels etc. can be provided to a user based on the position of the sensor data associated with an undefined movement performed by the user. In this manner, the computing system can analyze sensor data to automatically detect and/or classify user movements without the user movements having been previously defined by the system. Such a technique can enable users to perform new movements and have those movements identified in a continuous embedding space. Moreover, these new movements can be analyzed and compared with other movements within the continuous embedding space so that rankings, scores, or other indications of the position of new movements within a continuous embedding space can be generated.

In accordance with example embodiments of present disclosure, a gaming or other application of a computing system can be integrated with real life movements, including undefined movements, as can be performed by a user and detected by one or more sensors of a wearable device. A user may perform a new movement while wearing an interactive object such as a wearable device that includes one or more sensors (e.g., inertial measurement unit, capacitive touch sensor, etc.). The one or more sensors can generate sensor data that is indicative of the new movement performed by the user. The computing system can project the sensor data into a learned, continuous embedding space to generate position data for the new movement in the continuous embedding space. The position data can include data indicative of one or more motion categorizations, including levels associated with the one or more motion categorizations. In some examples, the levels associated with the one or more motion categorizations can be provided as scores or other indications associated with target criteria of the application. For example, the computing system can project sensor data associated with the new movement into the learned continuous embedding space in order to assign the new movement “difficulty” and/or “execution” scores. The scores can be used to provide gaming features to a user, such as in game rewards and gear including badges and uniforms. In some examples, a user can assign a name or other indication to a new movement. The new movement can be stored as part of a user profile and later shared publicly or with select groups of users such as friends. In some examples, a user can perform the new movement additional times to try to improve the position data associated with the new movement.

In accordance with example embodiments of the disclosed technology, a machine learned system is provided that is configured to automatically group undefined activities, motions, and/or interactions based on a number of predefined criteria. Such an approach can be contrasted with processes that attempt to directly recognize a specific and known activity, motion, or interaction. Rather, a machine learned approach is provided that includes one or more machine-learned models that are configured to learn a continuous embedding space in which activities, motions, and/or interactions can be automatically grouped based on a number of predefined criteria. The predefined criteria can be selected based on a particular wearable device and/or application such that the predefined criteria are not fixed. For instance, the predefined criteria for a first gaming application may be different than the predefined criteria for a second gaming application. Additionally or alternatively, the predefined criteria for a first wearable device may be different than the predefined criteria for a second wearable device. Sensor data associated with an unknown activity, motion, and/or interaction can be projected into the continuous embedding space that is learned based on the predefined criteria. A position of the unknown activity, motion, and/or interaction within the continuous embedding space can be generated. The position of the unknown activity, motion, and/or interaction within the continuous embedding space can be analyzed in order to initiate one or more functionalities at the computing system. For example, a functionality associated with an application can be initiated based at least in part on the position of the new movement within the continuous embedding space. As a specific example, a resulting event can be triggered within a wearable sensing platform, such as by rewarding a user within a gaming or other application.

As a specific example, consider a computer application such as a sports gaming application where a product designer seeks to reward users of the application for inventing and performing novel user movements. For instance, a soccer gaming application may be designed that is capable of rewarding users for inventing and performing novel, and possibly complex, soccer tricks. A set of predefined criteria can be formulated for training a machine learned embedding space. One or more training constraints can be formulated based on the set of predefined criteria in example embodiments. By way of example and not limitation, the set of predefined criteria may include a motion complexity criteria associated with a complexity of motions. For example, the motion complexity criteria may associate lower complexities with simple movements (e.g., simple jumps or kicks being on one side of the spectrum), and may associate higher complexities with more challenging movements (e.g., tricks that involve several spins/rotations of the user and/or ball being on the opposite side of the spectrum). The set of predefined criteria may include a motion intensity criteria associated with a velocity of motions. For example, the motion intensity criteria may associate lower intensities with lower velocities and higher intensities with higher velocities (e.g., a trick where the user spins and kicks very quickly may be afforded a higher score or receive more rewards than the same trick performed at a lower speed). The set of predefined criteria may include a motion skill criteria associated with a skill of the motion. For example, the motion skill criteria may associate a lower skill with poorly performed motions and a higher skill with more smoothly performed motions (e.g, poorly with several errors or smoothly with high degree of control).

One or more machine learned models of the machine learned system can be trained by providing examples of one or more motions to the one or more machine learned models in order to learn the continuous embedding space. Rather than analyzing specific sensor data that makes up a specific trick in order to recognize the specific trick, the one or more machine learned models can learn a continuous embedding space to enable the models to recognize descriptive categories of data related to user actions, and to measure them against other readings such as an ideal reading in order to rank or otherwise analyze them. As a specific example, the one or more machine learned models can be trained by providing sensor data associated with movements performed by a skilled user. In some examples, the sensor data is not annotated to identify a particular motion. Rather, sensor data associated with skillfully performed motions such as from a highly skilled player can be provided to the one or more machine learned models as an ideal benchmark against which future sensor data can be measured. The sensor data associated with the motions performed by the highly skilled player can be provided to the one or more machine learned models based on the predefined criteria. In this manner, the one or more machine learned models can learn the continuous embedding space based at least in part on the predefined criteria and the example motions provided in the way of sensor data. In some examples, sensor data associated with skillfully performed motions can be provided to the machine learned models during training, such as in the form of positive training data examples. By contrast, sensor data associated with low skillfully performed motions can be provided to the machine learned models during training, such as in the form of negative training data examples.

After a continuous embedding space has been learned, new activities, motions, and/or interactions can be projected into the continuous embedding space. A position of the new activity, motion, and/or interaction within the continuous embedding space can be determined based on the projection. The position of the new activity, motion, and/or interaction can be used to trigger a resulting functionality within the wearable sensing platform. For example, sensor data associated with a new movement created by a user can be provided as input to the one or more machine learned models. The one or more machine learned models can provide an output that includes position data within a continuous embedding space. The position data may include data indicative of one or more motion categorizations. For instance, if the user creates a new movement that the system determines has a fairly complex motion, and was performed with medium intensity, and with a high degree of skill, the position of the user motion within the continuous embedding space can be used to provide a large reward to the user and the accompanying application. This can be achieved without having to explicitly know the exact user motion a priori, or without having to explicitly detect and/or define the motion.

According to some aspects of the disclosed technology, sensor data that is associated with an undefined user movement can be obtained by a computing system. The computing system can project the sensor data into a learned continuous embedding space. The computing system can determine a position of the sensor data within the continuous embedding space based on the projection. For example, the computing system can input the sensor data into a machine learned model that has been trained to learn the continuous embedding space. The machine learned model can project and determine the position of the sensor data within the learned continuous embedding space. Additionally, in some examples, the machine learned model can determine one or more motion categorizations based on the position of the sensor data. For instance, the machine learned model can determine one or more levels associated with each of the motion categorizations. The computing system can obtain as an output of the machine learned model data indicative of the position of the sensor data within the continuous embedding space. The computing system can determine and initiate a functionality associated with the position of the sensor data within the continuous embedding space. In some examples, the data indicative of the position of the sensor data within the continuous embedding space can include data indicative of the level of the sensor data within the one or more motion categorizations. The machine learned model can optionally create a motion signature based on the position of the sensor data and/or the motion categorizations associated with sensor data.

In some examples, the computing system can access data indicative of a motion signature that is generated in response to sensor data associated with one or more sensors of a second wearable device. The computing system can compare the position of the sensor data within the continuous embedding space to the motion signature to generate one or more comparison results. The computing system can generate a score or other indication that is indicative of a performance by the user of the motion corresponding to the motion signature.

In accordance with example embodiments of the disclosed technology, a machine learned model can be trained to generate position data within a continuous embedding space in response to sensor data indicative of one or more undefined user movements. For example, data descriptive of a machine learned model can be generated such that the machine learned model is configured for motion detection and classification of unknown motions. One or more training constraints can be formulated based on target criteria associated with a product such as a wearable device, or application such as a computer gaming application. For instance, the target criteria may represent motion complexity, motion intensity, and/or motion skill associated with new movements performed by users of the product and/or computer gaming application. Training data can be provided to the machine learned model based on the predefined criteria. The training data can include sensor data associated with examples of multiple motions that can be performed by a user. In some examples, the sensor data can be associated with a skilled user performing the motions. In some examples, the training data is not annotated to indicate a specific motion, activity, or interaction. In some examples, the training data can be annotated to indicate levels associated with the predefined criteria. For example, the sensor data can be annotated to indicate a high level of motion complexity, motion intensity, and motion skill associated with motions performed by a highly skilled user. In response to the training data, the machine learned model can generate data indicative of a position of the training data within a continuous embedding space. In some examples, the data can include data indicative of one or more motion categorizations and/or levels associated with the motion categorizations. The computing system can detect one or more errors associated with the data indicative of the position. For example, the computing system can determine that the position determined by the machine learned model does not correspond to the annotation of the sensor data. The computing system can determine one or more loss function parameters based on the errors and backpropagate the loss function parameters in order to modify the machine learned model.

According to some implementations, the machine-learned system can be provisioned at one or more computing devices. The one or more computing devices can include computing devices at an interactive object such as a wearable device, and/or computing devices remote from the interactive object, such as smart phone, desktop, tablet, cloud computing system, etc.

As a specific example, an interactive object in accordance with some example embodiments can include a capacitive touch sensor comprising one or more sensing elements such as conductive threads. A touch input to the capacitive touch sensor can be detected by the one or more sensing elements using sensing circuitry connected to the one or more sensing elements. The sensing circuitry can generate sensor data based on the touch input. The sensor data can be analyzed by a machine-learned model as described herein to detect one or more previously undefined user movements such as a gesture based on the touch input or other motion input. For instance, the sensor data can be provided to the machine-learned model implemented by one or more computing devices of a wearable sensing platform (e.g., including an interactive object).

As another example, an interactive object can include an inertial measurement unit configured to generate sensor data indicative of acceleration, velocity, and other movements. The sensor data can be analyzed by a machine-learned model as described herein to detect or recognize movements such as running, walking, sitting, jumping or other movements. In some examples, a removable electronics module can be implemented within a shoe or other garment, garment accessory, or garment container. The sensor data can be provided to the machine-learned model implemented by a computing device of the removable electronics module at the interactive object. The machine-learned model can generate data associated with one or more undefined movements detected by an interactive object.

In some examples, a movement manager can be implemented at one or more of the computing devices at which the machine-learned model is provisioned. The movement manager may include one or more portions of a machine-learned model in some examples. In some examples, the movement manager may include portions of the machine-learned model at multiple ones of the computing devices at which the machine-learned model is provisioned. The movement manager can be configured to initiate one or more actions in response to detecting a new user movement. For example, the movement manager can be configured to provide data indicative of the new user movement to other applications at a computing device. By way of example, a detected user movement can be utilized within a health monitoring application or a game implemented at a local or remote computing device. A detected gesture can be utilized by any number of applications to perform a function within the application.

Systems and methods in accordance with the disclosed technology provide a number of technical effects and benefits. As one example, the systems and methods described herein can enable a computing system to utilize machine-learned models to detect and/or classify previously undefined user movements. More particularly, one or more machine-learned models can be trained to learn a continuous embedding space for projecting sensor data associated with previously undefined user movements. In this manner, the machine-learned models can generate data indicative of a position or other signature of the user movement within the continuous embedding space. As such, the system can provide rankings, scores, or other data for new movements that have not been defined by the computing system.

The use of a continuous embedding space provides significant improvements to traditional processes that attempt to directly recognize a specific and known activity, motion, or interaction. By contrast, a machine learned model as described herein can learn a continuous embedding space in which activities, motion, and/or interactions can be automatically grouped based on a number of predefined criteria. These criteria can be changed based on a particular device (e.g., interactive shoe, jacket, backpack, etc.) and/or a particular computing application (e.g., gaming application, social application, etc.). The target criteria are not fixed and thus enable the continuous embedding space to be learned such that unknown activities, motions, and/or interactions performed by a user can be projected into the continuous embedding space. This allows the position of the data within the continuous embedding space to be compared with data associated with other user movements projected to the continuous embedding space. In this manner, previously undefined user movement can be utilized to trigger resulting events within a wearable sensing platform, such as by rewarding a user within a computing application.

As such, aspects of the present disclosure can improve gesture detection, movement recognition, and other machine-learned processes that are performed using sensor data collected at relatively lightweight computing devices, such as those included within interactive objects. In this manner, the systems and methods described here can provide a more efficient and/or accurate operation of a machine-learned model over one or more computing devices in order to perform classifications and other processes efficiently. For instance, a machine-learned model can be optimized for the particular computing resources and/or sensor at a particular interactive object and/or computing application. Another machine-learned model can be optimized for the particular computing resources and/or sensor at a different interactive object and/or computing application. By optimizing machine-learned models in such a manner, previously undefined user movements can be detected, classified, ranked, and/or scored. Additionally, bandwidth usage and other computational resources can be minimized.

In some implementations, in order to obtain the benefits of the techniques described herein, the user may be required to allow the collection and analysis of location information associated with the user or their device. For example, in some implementations, users may be provided with an opportunity to control whether programs or features collect such information. If the user does not allow collection and use of such signals, then the user may not receive the benefits of the techniques described herein. The user can also be provided with tools to revoke or modify consent. In addition, certain information or data can be treated in one or more ways before it is stored or used, so that personally identifiable information is removed. As an example, a computing system can obtain real-time location data which can indicate a location, without identifying any particular user(s) or particular user computing device(s).

With reference now to the figures, example aspects of the present disclosure will be discussed in greater detail.

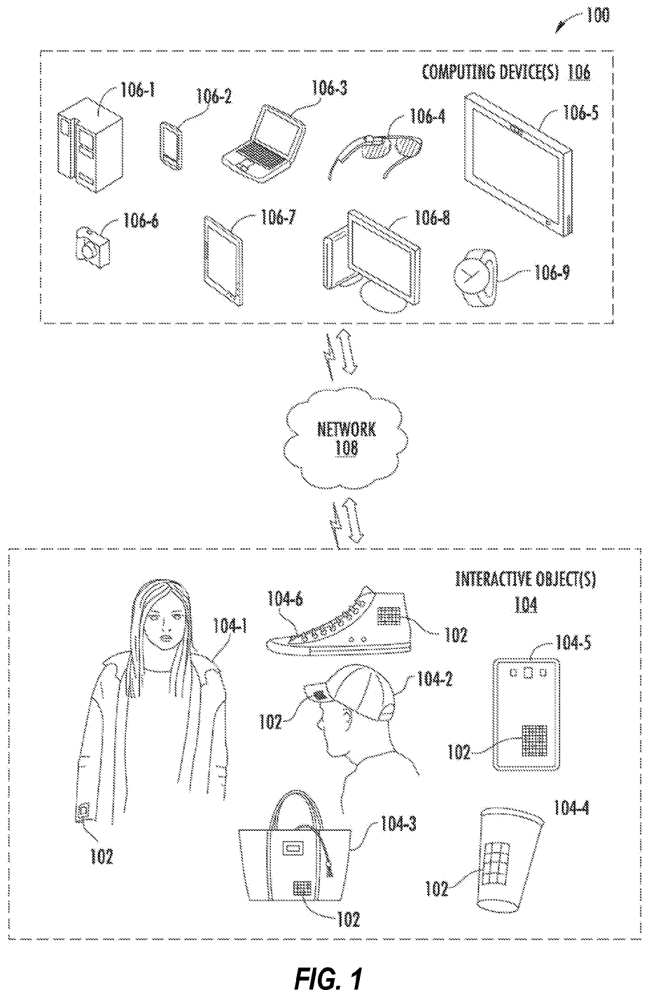

FIG. 1 is an illustration of an example environment 100 including an interactive object associated with a machine-learned model in accordance with example embodiments of the present disclosure. Environment 100 includes various interactive objects 104 which can include a touch sensor 102 or other input device. Touch sensor 102 can include capacitive touch sensors and/or resistive touch sensors. Touch sensor 102 can be integrated as an interactive textile or other flexible interactive material that is configured to sense touch-input (e.g., multi-touch input). As described herein, a textile may include any type of flexible woven material consisting of a network of natural or artificial fibers, often referred to as thread or yarn. Textiles may be formed by weaving, knitting, crocheting, knotting, pressing threads together or consolidating fibers or filaments together in a nonwoven manner.

In environment 100, interactive objects 104 include “flexible” objects, such as a shirt 104-1, a hat 104-2, a handbag 104-3 and a shoe 104-6. It is to be noted, however, that capacitive touch sensor 102 may be integrated within any type of flexible object made from fabric or a similar flexible material, such as garments or articles of clothing, garment accessories, garment containers, blankets, shower curtains, towels, sheets, bed spreads, or fabric casings of furniture, to name just a few. Examples of garment accessories may include sweat-wicking elastic bands to be worn around the head, wrist, or bicep. Other examples of garment accessories may be found in various wrist, arm, shoulder, knee, leg, and hip braces or compression sleeves. Headwear is another example of a garment accessory, e.g. sun visors, caps, and thermal balaclavas. Examples of garment containers may include waist or hip pouches, backpacks, handbags, satchels, hanging garment bags, and totes. Garment containers may be worn or carried by a user, as in the case of a backpack, or may hold their own weight, as in rolling luggage. Touch sensor 102 may be integrated within flexible objects 104 in a variety of different ways, including weaving, sewing, gluing, and so forth.

In this example, objects 104 further include “hard” objects, such as a plastic cup 104-4 and a hard smart phone casing 104-5. It is to be noted, however, that hard objects 104 may include any type of “hard” or “rigid” object made from non-flexible or semi-flexible materials, such as plastic, metal, aluminum, and so on. For example, hard objects 104 may also include plastic chairs, water bottles, plastic balls, or car parts, to name just a few. In another example, hard objects 104 may also include garment accessories such as chest plates, helmets, goggles, shin guards, and elbow guards. Alternatively, the hard or semi-flexible garment accessory may be embodied by a shoe, cleat, boot, or sandal. Touch sensor 102 may be integrated within hard objects 104 using a variety of different manufacturing processes. In one or more implementations, injection molding is used to integrate touch sensors into hard objects 104.

Touch sensor 102 enables a user to control an object 104 with which the capacitive touch sensor 102 is integrated, or to control a variety of other computing devices 106 via a network 108. Computing devices 106 are illustrated with various non-limiting example devices: server 106-1, smart phone 106-2, laptop 106-3, computing spectacles 106-4, television 106-5, camera 106-6, tablet 106-7, desktop 106-8, and smart watch 106-9, though other devices may also be used, such as home automation and control systems, sound or entertainment systems, home appliances, security systems, netbooks, and e-readers. Note that computing device 106 can be wearable (e.g., computing spectacles and smart watches), non-wearable but mobile (e.g., laptops and tablets), or relatively immobile (e.g., desktops and servers). Computing device 106 may be a local computing device, such as a computing device that can be accessed over a bluetooth connection, near-field communication connection, or other local-network connection. Computing device 106 may be a remote computing device, such as a computing device of a cloud computing system.

Network 108 includes one or more of many types of wireless or partly wireless communication networks, such as a local-area-network (LAN), a wireless local-area-network (WLAN), a personal-area-network (PAN), a wide-area-network (WAN), an intranet, the Internet, a peer-to-peer network, point-to-point network, a mesh network, and so forth.

Touch sensor 102 can interact with computing devices 106 by transmitting touch data or other sensor data through network 108. Additionally or alternatively, touch sensor 102 may transmit gesture data, movement data, or other data derived from sensor data generated by the capacitive touch sensor 102. Computing device 106 can use the touch data to control computing device 106 or applications at computing device 106. As an example, consider that capacitive touch sensor 102 integrated at shirt 104-1 may be configured to control the user's smart phone 106-2 in the user's pocket, television 106-5 in the user's home, smart watch 106-9 on the user's wrist, or various other appliances in the user's house, such as thermostats, lights, music, and so forth. For example, the user may be able to swipe up or down on capacitive touch sensor 102 integrated within the user's shirt 104-1 to cause the volume on television 106-5 to go up or down, to cause the temperature controlled by a thermostat in the user's house to increase or decrease, or to turn on and off lights in the user's house. Note that any type of touch, tap, swipe, hold, or stroke gesture may be recognized by capacitive touch sensor 102.

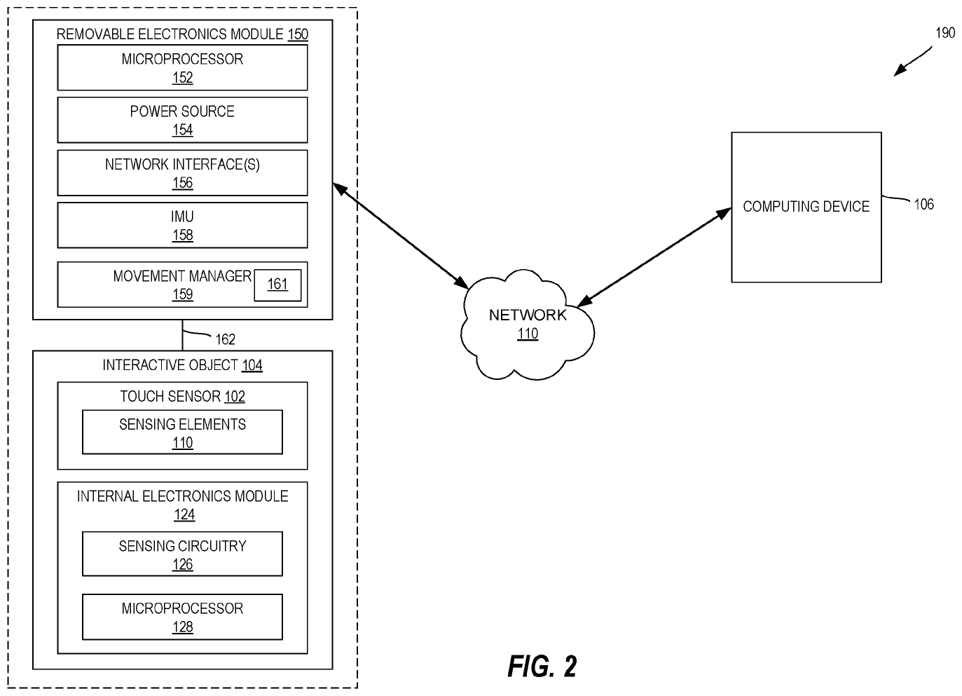

In more detail, consider FIG. 2 which illustrates an example system 200 that includes an interactive object 104, a removable electronics module 150, a local computing device 170, and a remote computing device 180. In system 200, capacitive touch sensor 102 is integrated in an object 104, which may be implemented as a flexible object (e.g., shirt 104-1, hat 104-2, or handbag 104-3) or a hard object (e.g., plastic cup 104-4 or smart phone casing 104-5).

Touch sensor 102 is configured to sense touch-input from a user when one or more fingers of the user's hand touch sensor 102. Touch sensor 102 may be configured to sense single-touch, multi-touch, and/or full-hand touch-input from a user. To enable the detection of touch-input, touch sensor 102 includes sensing elements, which can be formed as a grid, array, or parallel pattern so as to detect touch input. In some implementations, the sensing elements 110 do not alter the flexibility of touch sensor 102, which enables touch sensor 102 to be easily integrated within interactive objects 104.

Interactive object 104 includes an internal electronics module 124 that is embedded within interactive object 104 and is directly coupled to sensing elements 110. Internal electronics module 124 can be communicatively coupled to a removable electronics module 150 via a communication interface 162. Internal electronics module 124 contains a first subset of electronic circuits or components for the interactive object 104, and removable electronics module 150 contains a second, different, subset of electronic circuits or components for the interactive object 104. As described herein, the internal electronics module 124 may be physically and permanently embedded within interactive object 104, whereas the removable electronics module 150 may be removably coupled to interactive object 104.

In environment 190, the electronic components contained within the internal electronics module 124 includes sensing circuitry 126 that is coupled to sensing elements 110 that form the capacitive touch sensor 102. In some examples, the internal electronics module comprises a flexible printed circuit board (PCB). The printed circuit board can include a set of contact pads for attaching to the conductive lines. In some examples, the printed circuit board includes a microprocessor. For example, wires from conductive threads may be connected to sensing circuitry 126 using flexible PCB, creping, gluing with conductive glue, soldering, and so forth. In one embodiment, the sensing circuitry 126 can be configured to detect a user-inputted touch-input on the conductive threads that is pre-programmed to indicate a certain request. In one embodiment, when sensing elements such as conductive threads form a grid or other pattern, sensing circuitry 126 can be configured to also detect the location of the touch-input on sensing element 110, as well as motion of the touch-input. For example, when an object, such as a user's finger, touches sensing element 110, the position of the touch can be determined by sensing circuitry 126 by detecting a change in capacitance on the grid or array of sensing element 110. The touch-input may then be used to generate touch data usable to control a computing device 106. For example, the touch-input can be used to determine various gestures, such as single-finger touches (e.g., touches, taps, and holds), multi-finger touches (e.g., two-finger touches, two-finger taps, two-finger holds, and pinches), single-finger and multi-finger swipes (e.g., swipe up, swipe down, swipe left, swipe right), and full-hand interactions (e.g., touching the textile with a user's entire hand, covering textile with the user's entire hand, pressing the textile with the user's entire hand, palm touches, and rolling, twisting, or rotating the user's hand while touching the textile).

Communication interface 162 enables the transfer of power and data (e.g., the touch-input detected by sensing circuitry 126) between the internal electronics module 124 and the removable electronics module 150. In some implementations, communication interface 162 may be implemented as a connector that includes a connector plug and a connector receptacle. The connector plug may be implemented at the removable electronics module 150 and configured to connect to the connector receptacle, which may be implemented at the interactive object 104.

In system 200, the removable electronics module 150 includes a microprocessor 152, power source 154, network interface(s) 156, and inertial measurement unit 158. Power source 154 may be coupled, via communication interface 162, to sensing circuitry 126 to provide power to sensing circuitry 126 to enable the detection of touch-input, and may be implemented as a small battery. In one or more implementations, communication interface 162 is implemented as a connector that is configured to connect removable electronics module 150 to internal electronics module 124 of interactive object 104. When touch-input is detected by sensing circuitry 126 of the internal electronics module 124, data representative of the touch-input may be communicated, via communication interface 162, to microprocessor 152 of the removable electronics module 150. Microprocessor 152 may then transmit the touch-input data and/or analyze the touch-input data to generate one or more control signals, which may then be communicated to computing device 106 (e.g., a smart phone) via the network interface 156 to cause the computing device 106 to initiate a particular functionality. Generally, network interfaces 156 are configured to communicate data, such as touch data, over wired, wireless, or optical networks to computing devices 106. By way of example and not limitation, network interfaces 156 may communicate data over a local-area-network (LAN), a wireless local-area-network (WLAN), a personal-area-network (PAN) (e.g., Bluetooth™), a wide-area-network (WAN), an intranet, the Internet, a peer-to-peer network, point-to-point network, a mesh network, and the like (e.g., through network 108).

The inertial measurement unit(s) (IMU(s)) 158 can generate sensor data indicative of a position, velocity, and/or an acceleration of the interactive object. The IMU(s) 158 may generate one or more outputs describing one or more three-dimensional motions of the interactive object 104. The IMU(s) may be secured to the internal electronics module 124, for example, with zero degrees of freedom, either removably or irremovably, such that the inertial measurement unit translates and is reoriented as the interactive object 104 is translated and are reoriented. In some embodiments, the inertial measurement unit(s) 158 may include a gyroscope or an accelerometer (e.g., a combination of a gyroscope and an accelerometer), such as a three axis gyroscope or accelerometer configured to sense rotation and acceleration along and about three, generally orthogonal axes. In some embodiments, the inertial measurement unit(s) may include a sensor configured to detect changes in velocity or changes in rotational velocity of the interactive object and an integrator configured to integrate signals from the sensor such that a net movement may be calculated, for instance by a processor of the inertial measurement unit, based on an integrated movement about or along each of a plurality of axes.

While internal electronics module 124 and removable electronics module 150 are illustrated and described as including specific electronic components, it is to be appreciated that these modules may be configured in a variety of different ways. For example, in some cases, electronic components described as being contained within internal electronics module 124 may be at least partially implemented at the removable electronics module 150, and vice versa. Furthermore, internal electronics module 124 and removable electronics module 150 may include electronic components other that those illustrated in FIG. 2, such as sensors, light sources (e.g., LED's), displays, speakers, and so forth.

A movement manager 159 can be implemented by one or more computing devices in computing environment 190. In the example of FIG. 2, movement manager 159 is implemented at removable electronics module 150. It will be appreciated, however, that movement manager 159 may be implemented additionally or alternatively at interactive object 104 and/or a computing device 106. The movement manager can be capable of interacting with applications at computing devices 106, touch sensor 102, and/or IMU(s) 158. The movement manager is effective to activate various functionalities associated with computing devices (e.g., computing devices 106) and/or applications through touch-input (e.g., gestures) received by capacitive touch sensor 102 and/or motion detected by IMU(s) 158. The movement manager may be implemented at a computing device that is local to object 104, or remote from object 104. The movement manager can be capable of interacting with applications at computing devices and inertial measurement unit 158 effective to activate various functionalities associated with computing devices and/or applications through movement detected by inertial measurement unit 158.

The movement manager can utilize one or more machine-learned models of machine learned system 161 for detecting gestures and movements associated with interactive object 104. As described in more detail hereinafter, the one or more machine-learned models can be configured to detect, classify, analyze, and/or generate scores and rankings associated with previously undefined user movements. For example, a machine-learned model can be implemented by microprocessor 128, microprocessor 152, local computing device 170, and/or remote computing device 180.

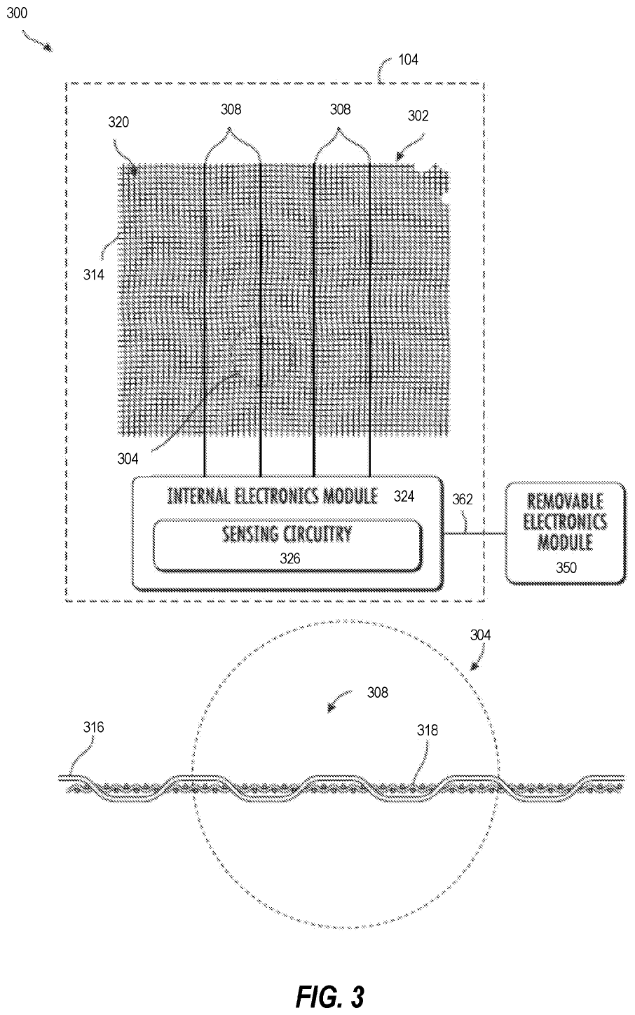

FIG. 3 illustrates an example 300 of interactive object 104 with multiple electronics modules in accordance with one or more implementations. In this example, a capacitive touch sensor 302 of the interactive object 304 includes non-conductive threads 314 woven with conductive threads 308 to form touch sensor 102 (e.g., interactive textile). Conductive threads 308 are one example of sensing elements 110. It will be appreciated that additional types of sensing elements 110 may be used. Non-conductive threads may correspond to any type of non-conductive thread, fiber, or fabric, such as cotton, wool, silk, nylon, polyester, and so forth. Touch sensor 302 can be configured as a capacitive touch sensor or resistive touch sensor in example embodiments. Together, non-conductive threads 314 and conductive threads 308 form a textile or textile-based substrate 320.

At 304, a zoomed-in view of conductive thread 308 is illustrated. Conductive thread 308 includes a conductive wire 316 or a plurality of conductive filaments that are twisted, braided, or wrapped with a flexible thread 318. As shown, the conductive thread 308 can be woven or otherwise integrated with the non-conductive threads to form a fabric or a textile-based substrate 320. Although a conductive thread and textile is illustrated, it will be appreciated that other sensing elements and substrates may be used, such as flexible metal lines formed on a plastic substrate.

In one or more implementations, conductive thread 308 includes a thin copper wire. It is to be noted, however, that the conductive thread 308 may also be implemented using other materials, such as silver, gold, or other materials coated with a conductive material. The conductive thread 308 may include an outer cover layer formed by braiding together non-conductive threads. The non-conductive threads may be implemented as any type of flexible thread or fiber, such as cotton, wool, silk, nylon, polyester, and so forth.

Conductive wire 316 may be combined with flexible threads 318 in a variety of different ways, such as by twisting flexible threads 318 with conductive wire 316, wrapping flexible threads 318 with conductive wire 316, braiding or weaving flexible threads 318 to form a cover that covers conductive wire 316, and so forth. Conductive wire 316 may be implemented using a variety of different conductive materials, such as copper, silver, gold, aluminum, or other materials coated with a conductive polymer. Flexible thread 318 may be implemented as any type of flexible thread or fiber, such as cotton, wool, silk, nylon, polyester, and so forth.

Combining conductive wire 316 with flexible thread 318 causes sensing element 110 to be flexible and stretchy, which enables conductive thread 308 to be easily woven with one or more non-conductive threads 314 (e.g., cotton, silk, or polyester). In one or more implementations, conductive thread includes a conductive core that includes at least one conductive wire 316 (e.g., one or more copper wires) and a cover layer, configured to cover the conductive core, that is constructed from flexible threads 318 In some cases, conductive wire 316 of the conductive core is insulated. Alternately, conductive wire 316 of the conductive core is not insulated.

In one or more implementations, the conductive core may be implemented using a single, straight, conductive wire 316. Alternately, the conductive core may be implemented using a conductive wire 316 and one or more flexible threads 318. For example, the conductive core may be formed by twisting one or more flexible threads 318 (e.g., silk threads, polyester threads, or cotton threads) with conductive wire 316, or by wrapping flexible threads 318 around conductive wire 316

Touch sensor 302 can be formed efficiently and in a low-cost manner, using any conventional weaving process (e.g., jacquard weaving or 3D-weaving), which involves interlacing a set of longer threads (called the warp) with a set of crossing threads (called the weft). Weaving may be implemented on a frame or machine known as a loom, of which there are a number of types. Thus, a loom can weave non-conductive threads 314 with conductive threads 308 to create touch sensor 302.

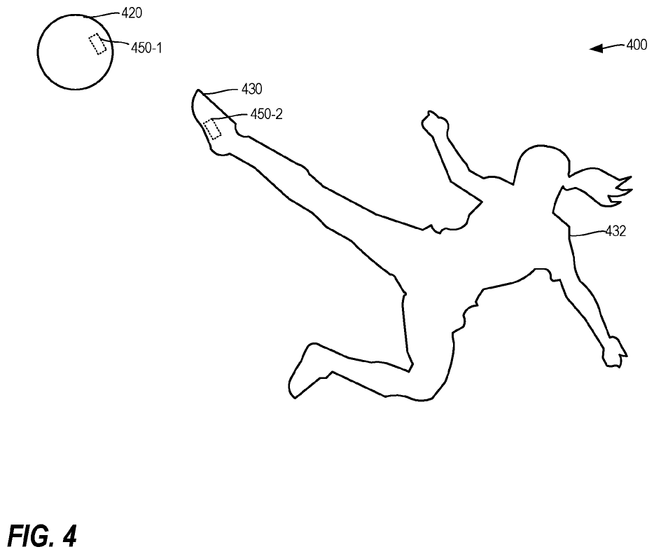

FIG. 4 is a block diagram depicting an example computing environment 400 in which a machine-learned system can be provisioned in accordance with an example implementation of the present disclosure. Computing environment 400 includes a removable electronics module 450-1 integrated with a soccer ball 420 and a removable electronics module 450-2 integrated with a shoe 430 worn by a user 432. It will be appreciated that two removable electronics modules are provided by way of example only, and that more or fewer removable electronics modules may be included in example embodiments.

User 432 is illustrated during the performance of a previously undefined user movement in association with the soccer ball 420. One or more sensors such as one or more inertial measurement units included within removable electronics modules 450-1 and/or 450-2 can generate sensor data associated with the user movement and provide the sensor data to a movement manager implemented by a remote computing device 106 as shown in FIG. 2 and/or a computing device of removable electronics module 150 and/or internal electronics module 124. The movement manager can analyze the sensor data associated with the previously undefined user movement to initiate one or more functionalities associated with the user movement.

By way of example, user 432 may perform a new user movement such as new soccer trick while the removable electronics module 450-1 at soccer ball 420 and/or the removable electronics module 450-2 at shoe 430 generate sensor data associated with the new user movement. The new user movement can be a movement known or unknown to others but that is previously undefined by movement manager 159. In some embodiments, a user may provide an input such as an input to removable electronics module 450-1/450-2 or a computing device 106 to indicate a start time and/or an end time associated with the new user movement. In some examples, a user can video themselves performing the new user movement using an application on a remote computing device 106 such as a smart phone and/or tablet. The user can mark the beginning and the end of the new user movement. In some examples, video data can be synced with timeseries sensor data which can allow the movement manager to precisely measure a movement timeline.

Movement manager 159 can analyze the sensor data and generate a unique motion signature associated with the unknown user movement. For example, movement manager 159 can input the sensor data into one or more machine learned models that are configured to generate the unique motion signature. In some examples, the unique signature can be recorded. Later efforts by the user or other users using other wearable devices can be measured against the baseline corresponding to the unique signature in order to determine how close the later efforts are to replicating the new user movement.

In some examples, movement manager 159 can utilize a machine learned system 161 to recognize descriptive categories of data related to user action, and optionally measure the user actions against an ideal or other baseline reading in order to rank the player actions. For example, descriptive categories may include how complex motion is, how intensely a motion is performed, and/or how skillfully the motion was performed. The machine learned system can include one or more machine learned models trained based at least in part on sensor data from user movements such as complex or noncomplex tricks performed by highly skilled or nonskilled players associated with the particular activity. The sensor data from the example user movements of a skilled player can provide ideal benchmarks against which future user movements can be measured. When a user's data is analyzed, movement manager 159 can match sensor data to levels in the motion categories, and in some cases ultimately be able to assign scores for attributes such as “complexity” and/or “execution”.

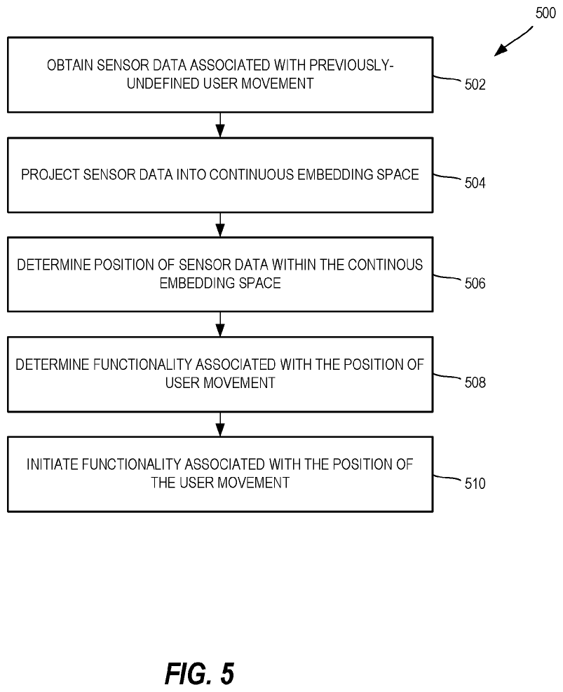

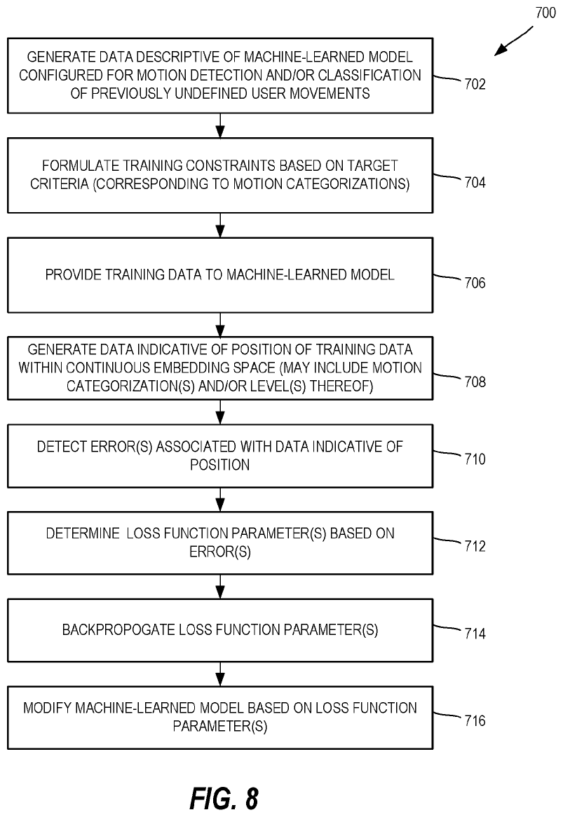

FIG. 5 is a flowchart depicting an example method 500 that includes processing sensor data to generate data associated with a previously undefined user movement, and to initiate a functionality associated with the previously undefined user movement. One or more portions of method 500 can be implemented by one or more computing devices such as, for example, one or more computing devices of a computing environment 100 as illustrated in FIG. 1, computing environment 190 as illustrated in FIG. 2, computing environment 400 as illustrated in FIG. 4, or a computing environment 1000 as illustrated in FIG. 8. One or more portions of method 500 can be implemented as an algorithm on the hardware components of the devices described herein to, for example, utilize a machine-learned model to process sensor data, generate data indicative of a position of the sensor data in a continuous embedding space, and to initiate a functionality based on the position of the sensor data in the continuous embedding space. In example embodiments, one or more portions of method 500 may be performed by a movement manager 159 and/or utilize one or more machine-learned models of a machine learned system 161 as illustrated in FIG. 2. The machine learned model may be implemented at a computing device of an internal electronics module or a removable electronics module of an interactive object, and/or a remote computing device from the interactive object as described herein. Although FIG. 5 depicts steps performed in a particular order for purposes of illustration and discussion, method 500 of FIG. 5 and methods 600, 650, and 700 described hereinafter are not limited to the particularly illustrated order or arrangement. The various steps of methods 500, 600, 650, and 700 can be omitted, rearranged, combined, and/or adapted in various ways without deviating from the scope of the present disclosure.

At 502, sensor data can be obtained that is associated with one or more previously undefined user movements. The sensor data can be generated by one or more sensors such as a capacitive touch sensor of an interactive object and/or an inertial measurement unit of a removable electronics device.

At 504, the sensor data can be projected into a continuous embedding space. In example embodiments, the continuous embedding space can be a learned, continuous embedding space and the sensor data can be projected into the continuous embedding space by one or more machine learned models. The use of a continuous embedding space that is learned by one or more machine learned models can bypass traditional processes that attempt to directly recognize a specific activity, motion, or interaction. The one or more machine learned models can be trained using machine learning to learn the continuous embedding space in which activities, motions, and/or interaction can be automatically grouped based on a number of predefined criteria.

At 506, a position of the previously undefined user movement as represented by the sensor data can be determined within the continuous embedding space based at least in part on the projected sensor data. The one or more machine learned models can receive the sensor data as an input and project the sensor data to a particular position within the continuous embedding space in example embodiments. One or more machine learned models can provide as an output, data indicative of the position of the sensor data within the continuous embedding space.

At 508, a functionality to be performed by a computing device can be determined that is associated with the position of the previously undefined user movement within the continuous embedding space. In some examples, one or more levels associated with one or more motion categorizations can be determined based on the projected sensor data. The one or more levels can be compared with one or more baseline levels in various embodiments. The functionality can be determined based on the comparison of the one or more levels of the sensor data to the one or more baseline levels.

At 510, the functionality associated with the position of the user movement can be initiated at the computing device. By way of example, a functionality can include generating a ranking or score associated with the new user movement. For instance, the position data associated with the new user movement can be compared to benchmarks embedded within the one or more machine learned models as part of the continuous embedding space. The functionality can include generating a ranking or score based on the comparison of the new user movement to the benchmarks and the one or more machine learned models.

As a simplified example, consider a skier going down a steep hill. An experienced skier may tend to use smooth, fluid motions as they set up their directional lines and follow those directional lines. An inexperienced skier may exhibit much choppier or otherwise less fluid motions as they continually readjust their direction and stance due to less awareness of how to execute. A sensor in one or more boots of each skier may generate very different sensor data from these two skiers even though they technically ski the same hill. The sensor data may be analyzed by the manager which can detect and group the smooth, fluid motions from the sensor data of the experience skier separately from the less fluid motions of the inexperienced skier, and assign scores or other indications accordingly.

As another example, consider a gaming application directed to skateboarding and the use of the one or more sensors within a skateboard or wearable device (e.g., sensor within a shoe) of a user while skateboarding. Sensor data may be generated by the one or more sensors in response to a previously undefined user movement such as a new skateboarding trick. The sensor data can be projected by the machine learned system into a continuous embedding space associated with target criteria of the gaming application. The projected sensor data can be used in determining a position of the new user movement within the continuous embedding space. The position of the new user movement within the continuous embedding space may include information indicative of motion criteria or motion categorizations such as motion complexity, motion intensity, and/or motion skill. A movement manager can utilize the machine learned system to determine one or more attributes associated with the new user movement. For example, if the user creates a new trick that has a fairly complex motion, and is performed with median intensity and with a high degree of skill, a position of the new user movement within the continuous embedding space can be used to provide a corresponding reward to the user and the accompanying skateboarding application. It is noted that this can be achieved without having to explicitly know about the exact user movement a priori, or without having to explicitly detect and/or define the new user movement. Additionally, in some examples the position within the embedding space can be used to rank or otherwise score a user's new user movement against similar or other user movements from other users. Again, this can be achieved without having to explicitly know about or previously define any of the user movements and/or the competing user's skill levels.

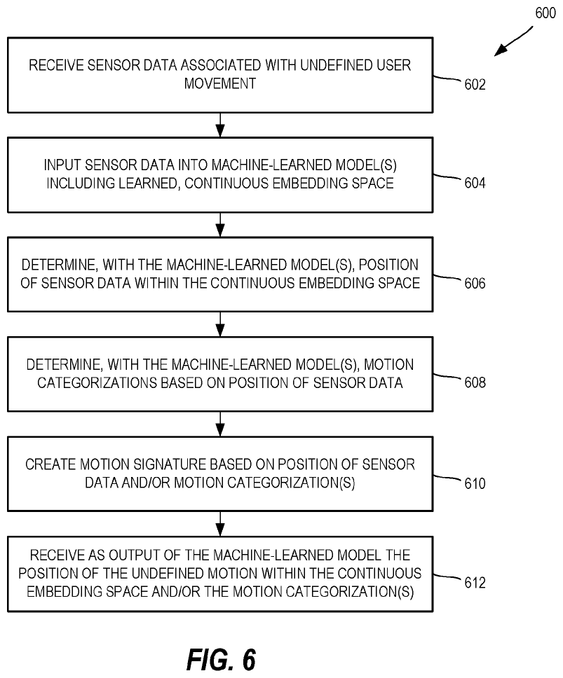

FIG. 6 is a flowchart depicting an example method 600 that includes processing sensor data by a machine-learned model to generate data indicative of a position or other motion signature associated with a previously undefined user movement. Method 600 can be utilized to generate data indicative of the position of sensor data within a continuous embedding space, and/or to generate data indicative of one or more motion categorizations associated with the sensor data. One or more portions of method 600 can be utilized at 504 and/or 506 of method 500. One or more portions of method 600 can be implemented by one or more computing devices such as, for example, one or more computing devices of a computing environment 100 as illustrated in FIG. 1, computing environment 190 as illustrated in FIG. 2, a computing environment 400 as illustrated in FIG. 4, or a computing environment 1000 as illustrated in FIG. 8. One or more portions of method 600 can be implemented as an algorithm on the hardware components of the devices described herein to, for example, utilize a machine-learned model to generate data indicative of a position and/or one or more motion categorizations of sensor data based on a learned, continuous embedding space. In example embodiments, one or more portions of method 600 may be performed by a movement manager 159 and/or utilize one or more machine-learned models of a machine learned system 161 as illustrated in FIG. 2. The machine learned model may be implemented at a computing device of an internal electronics module or a removable electronics module of an interactive object, and/or a remote computing device from the interactive object as described herein.

At 602, sensor data can be received that is associated with one or more previously undefined user movements. The sensor data can be received by movement manager 159 from one or more sensors of an interactive object in example embodiments.

At 604, the sensor data can be input into one or more machine learned models that are configured to project sensor data into a learned, continuous embedding space.

At 606, a position of the sensor data within the continuous embedding space can be determined using the machine learned model.

At 608, one or more motion categorizations can be determined using the machine learned model. The one or more motion categorizations can be based at least in part on the position of the sensor data as projected by the one or more machine learned models. In example embodiments, the one or more motion categorizations can include a level of the sensor data for each of the one or more motion categorizations.

At 610, a motion signature can be generated based at least in part on the position of the sensor data and/or the motion categorizations associated with the sensor data. In some examples, the motion signature can be an indication of the position of the sensor data within the continuous embedding space. The motion signature can optionally include data indicative of the one or more levels associated with the one or more motion categorizations.

At 612, data indicative of the position of the undefined user movement within the continuous embedding space and/or data indicative of the one or more motion categorizations can be received as an output of the machine learned model.

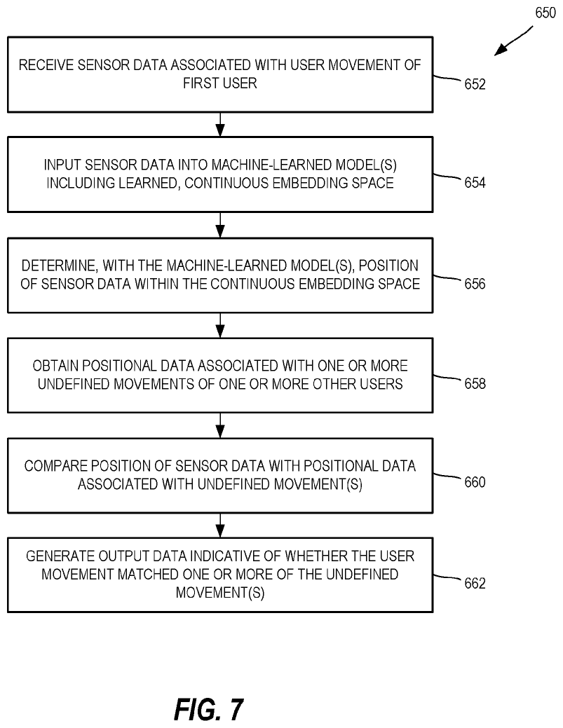

FIG. 7 is a flowchart depicting an example method 650 for comparing user movements with previously projected sensor data for one or more undefined user movements. The system can provide an output to a user indicating how well their motion matches an undefined user movement performed by one or more other users. In this manner, a sensor data projection of the user's movement can be compared with a sensor data projection for an undefined movement to determine a measure of similarity between the movements. The system can provide an output to a user that indicates whether and/or to what degree their movement matches a new trick, motion, gesture, etc. that they or another user performed. Method 650 can be utilized to generate one or more outputs such as data indicative of whether a user movement matches one or more previously projected movements. One or more portions of method 650 can be implemented by one or more computing devices such as, for example, one or more computing devices of a computing environment 100 as illustrated in FIG. 1, computing environment 190 as illustrated in FIG. 2, a computing environment 400 as illustrated in FIG. 4, or a computing environment 1000 as illustrated in FIG. 8. One or more portions of method 650 can be implemented as an algorithm on the hardware components of the devices described herein to, for example, utilize a machine-learned model to generate data indicative of a comparison between user movement and undefined movements having previously generated projections. In example embodiments, one or more portions of method 650 may be performed by a movement manager 159 and/or utilize one or more machine-learned models of a machine learned system 161 as illustrated in FIG. 2. The machine learned model may be implemented at a computing device of an internal electronics module or a removable electronics module of an interactive object, and/or a remote computing device from the interactive object as described herein.

At 652, sensor data associated with the user movement of the first user can be received. At 654, the sensor data can be input into one or more machine learned models including a learned, continuous embedding space.

At 656, a position of the sensor data within the continuous embedding space can be determined with the use of the one or more machine learned models. For example, the sensor data can be projected into the continuous embedding space using the one or more machine learned models. Data indicative of the position of the sensor data within the continuous embedding space can be generated at 656. In some examples, one or more motion categorizations can be determined based on the position of the sensor data within the continuous embedding space. For example, data indicative of a motion complexity, motion intensity, and/or skill level can be determined

At 658, the positional data associated with one or more undefined movements of one or more other users can be obtained. For example, the positional data generated by projecting the sensor data associated with one or more undefined movements can be obtained at 658. In some examples, data indicative of one or more motion categorizations associated with the one or more undefined movements can be obtained at 658.

At 660, the position of the sensor data associated with the user movement of the first user can be compared with the positional data associated with the undefined movements. For example, one or more values associated with one or more of a motion complexity, motion intensity, and/or skill level can be compared in some examples. The positional data may include data indicative of one or more values associated with a data characterization learned by the machine learned model. In some examples, one or more thresholds may be used at 660. For example, the system can determine whether the positional data associated with the movement of the first user satisfies one or more threshold associated with the additional data associated with undefined movement.

At 662, output data indicative of whether the user movement matches one or more of the undefined movements is generated. In some examples, the data can indicate whether or not the user movement is determined to match one or more of the undefined movements. For instance, if the positional data associated with the user movement satisfies one or more threshold associated with the one or more undefined movements, data indicating that the user successfully performed the undefined movement can be generated. In some examples, the output data generated at 662 can include data indicative of a degree to which the user movement matches one or more of the undefined movements. For example, the output data can include data indicating a similarity between a motion complexity of the user movement and motion complexity of the undefined movement. Similarly, the output data can include data indicating a similarity between a motion intensity and/or a skill level.

One or more user outputs can be generated at 662 in some implementations. For example, a user can receive an output such as a visual, audible, and/or haptic output indicating whether their movement matches one or more undefined movements of one or more other users.

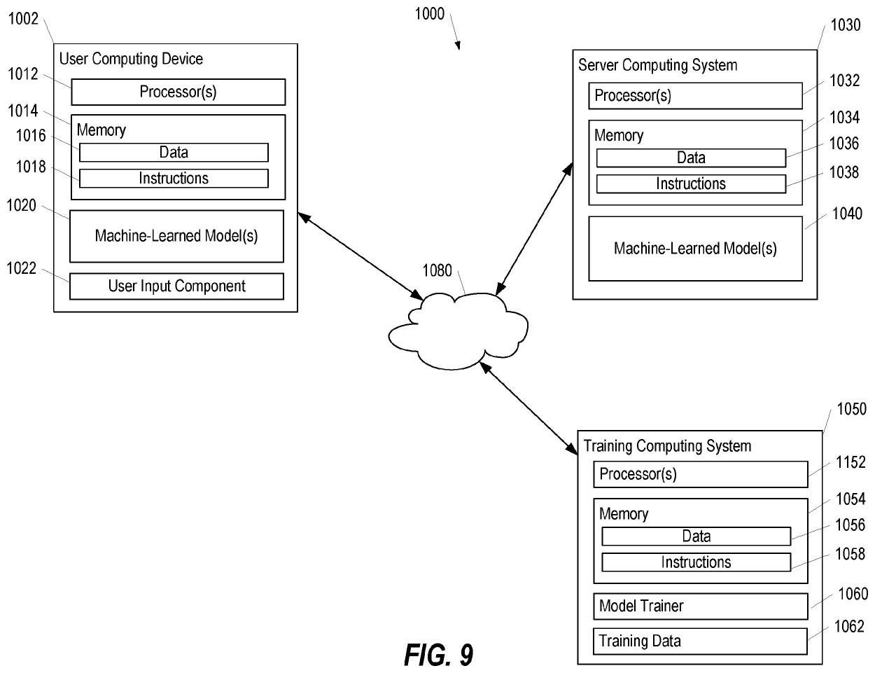

FIG. 8 is a flowchart depicting an example method 700 of training a machine-learned model that is configured to generate position data that indicates a position of a previously undefined user movement within a continuous embedding space. One or more portions of method 700 can be implemented by one or more computing devices such as, for example, one or more computing devices of a computing environment 100 as illustrated in FIG. 1, computing environment 190 as illustrated in FIG. 2, computing environment 400 as illustrated in FIG. 4, or a computing environment 1000 as illustrated in FIG. 8. One or more portions of method 700 can be implemented as an algorithm on the hardware components of the devices described herein to, for example, train a machine-learned model to process sensor data, and generate data indicative of a position of a previously undefined user movement within a continuous embedding space. In example embodiments, method 700 may be performed by a model trainer 1060 using training data 1062 as illustrated in FIG. 9.

At 702, data descriptive of a machine-learned model that is configured for motion detection and/or classification is generated.

At 704, one or more training constraints are formulated based on one or more target criteria associated with particular interactive object and/or particular computing application. In some examples, training constraints can be formulated based on predefined target criteria for a machine learned continuous embedding space. Any number and/or type of target criteria can be defined and corresponding training constraints formulated for such target criteria.

As a specific example, a product designer for a skateboarding computing application may create a system to reward users of the skateboarding application for inventing and performing novel and possibly complex new user movements (e.g., skateboarding tricks). The product designer may establish target criteria for a machine learning embedding space for the skateboarding gaming application. Examples of target criteria may include motion complexity, motion intensity, and/or motion skill. As a specific example, motion complexity target criteria may indicate that simple jumps are to be associated with a relatively low motion complexity, while user movements that include several spin/rotations of the user and/or the skateboard are to be associated with relatively high motion complexity. The motion intensity target criteria may indicate how fast a particular motion is performed. For instance, a new user movement where the skateboard is spun twice very quickly may be associated with a relatively high motion intensity whereas the same trick performed a much lower speed may be associated with a relatively low motion intensity. The motion skill criteria may be indicative of how skillfully a particular user movement is performed. For instance, a poorly performed user movement with several errors may be associated with a relatively low motion skill whereas a smoothly performed user movement with a high degree of control may be associated with a relatively high motion skill.

At 706, training data is provided to the machine learned model. The training data may include sensor data generated in response to example user movements. In some examples, the training data provides machine learning capabilities to recognize descriptive ‘categories’ of data related to player actions, and measure them against an ideal reading in order to rank them. For example, descriptive categories might include how complex a motion was, how intensely the motion happened, and how smoothly it was performed. The model(s) can be trained by taking in data from some user movements (e.g., complex tricks) performed by users (e.g., highly skilled players). The training data can provide an ‘ideal’ benchmark against which future movements can be measured. When a player's data is analyzed, the system can match sensor data to levels in these categories, and ultimately be able to assign scores for attributes like ‘complexity’ or ‘execution.’ In some examples, the training data may include positive training data examples and negative training data examples. The positive training data examples may be associated with desirable attributes of the target criteria whereas the negative training data examples may be associated with non-desirable attributes of the target criteria. By way of example, a skilled player or other user may perform example user movements and the generated sensor data utilized to train the machine learned model as a positive training data example. A less skilled player may perform the same user movements and the sensor data be utilized as negative training examples. In some embodiments, negative training data is not utilized.

At 708, data indicative of the position of the training data within the continuous embedding space is generated by the machine learned model. The data generated at 708 may include data indicative of one or more motion categorizations and/or levels within the one or more motion categorizations in example embodiments.

At 710, one or more errors associated with the data indicative of the position of the training data within the continuous embedding space are detected. By way of example, an error may be detected in response to the machine learned model generating position data indicative of a highly skilled user movement in response to training data associated with a low skill user movement. Similarly, an error may be detected in response to the machine learned model generating position data indicative of a low skilled user movement in response to training data that is associated with a highly skilled user movement.

At 712, one or more loss function parameters can be determined for the machine learned model based on the detected errors. In some examples, the loss function parameters can be based on an overall output of the machine-learned model. In other examples, a loss function parameter can be based on particular output, such as a level within a particular motion categorization. In some examples, a loss function parameter may include a sub-gradient.

At 714, the one or more loss function parameters are back propagated to the machine-learned model. For example, a sub-gradient calculated based on the detected errors can be back propagated to the machine-learned model.

At 716, one or more portions of the machine-learned model can be modified based on the backpropagation at 714.

FIG. 9 depicts a block diagram of an example computing system 1000 that can be used to implement of the computing devices described herein. The computing system 1000 can include a user computing device 1002, a server computing system 1030, and/or a training computing system 1050 that are communicatively coupled over a network 1080.

The user computing device 1002 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 1002 includes one or more processors 1012 and a memory 1014. The one or more processors 1012 can be any suitable processing device (e.g., a processor core, a microprocessor, an ASIC, a FPGA, a controller, a microcontroller, etc.) and can be one processor or a plurality of processors that are operatively connected. The memory 1014 can include one or more non-transitory computer-readable storage mediums, such as RAM, ROM, EEPROM, EPROM, flash memory devices, magnetic disks, etc., and combinations thereof. The memory 1014 can store data 1016 and instructions 1018 which are executed by the processor 1012 to cause the user computing device 1002 to perform operations.

The user computing device 1002 can include one or more portions of a machine-learned model 1020. In some implementations, the machine-learned model can store or include one or more portions of a movement recognition model. For example, the machine-learned model can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the machine-learned model can be received from the server computing system 1030 over network 1080, stored in the user computing device memory 1014, and then used or otherwise implemented by the one or more processors 1012. In some implementations, the user computing device 1002 can implement multiple parallel instances of the machine-learned model (e.g., to perform parallel inference generation across multiple instances of sensor data).

Additionally or alternatively to the machine-learned model 1020, the server computing system 1030 can include one or more machine-learned models 1040. The machine-learned model(s) 1040 can generate data indicative of a position of the previously undefined user movement within a continuous embedding space as described herein.

Additionally or alternatively to the machine learned models 1020, one or more machine learned models 1040 can be included in or otherwise stored and implemented by the server computing system 1030 that communicates with the user computing device 1002 according to a client-server relationship. For example, the machine learned models 1040 can be implemented by the server computing system 1030 as a portion of a web service (e.g., user movement recognition service). Thus, the machine learned models can be stored and implemented at the user computing device 1002 and/or at the server computing system 1030. The one or more machine learned models 1040 can be the same as or similar to the one or more machine learned models 1020.

The user computing device 1002 can also include one or more user input components 1022 that receive user input. For example, the user input component 1022 can be a touch-sensitive component (e.g., a capacitive touch sensor 102) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 1030 includes one or more processors 1032 and a memory 1034. The one or more processors 1032 can be any suitable processing device (e.g., a processor core, a microprocessor, an ASIC, a FPGA, a controller, a microcontroller, etc.) and can be one processor or a plurality of processors that are operatively connected. The memory 1034 can include one or more non-transitory computer-readable storage mediums, such as RAM, ROM, EEPROM, EPROM, flash memory devices, magnetic disks, etc., and combinations thereof. The memory 1034 can store data 1036 and instructions 1038 which are executed by the processor 1032 to cause the server computing system 1030 to perform operations.

In some implementations, the server computing system 1030 includes or is otherwise implemented by one or more server computing devices. In instances in which the server computing system 1030 includes plural server computing devices, such server computing devices can operate according to sequential computing architectures, parallel computing architectures, or some combination thereof.

As described above, the server computing system 1030 can store or otherwise include one or more machine learned models 1040. Example machine-learned models include neural networks or other multi-layer non-linear models. Example neural networks include feed forward neural networks, deep neural networks, recurrent neural networks, and convolutional neural networks. One example model is discussed with reference to FIG. 2.

The user computing device 1002 and/or the server computing system 1030 can train the machine learned models 1020 and/or 1040 via interaction with the training computing system 1050 that is communicatively coupled over the network 1080. The training computing system 1050 can be separate from the server computing system 1030 or can be a portion of the server computing system 1030.

The training computing system 1050 includes one or more processors 1052 and a memory 1054. The one or more processors 1052 can be any suitable processing device (e.g., a processor core, a microprocessor, an ASIC, a FPGA, a controller, a microcontroller, etc.) and can be one processor or a plurality of processors that are operatively connected. The memory 1054 can include one or more non-transitory computer-readable storage mediums, such as RAM, ROM, EEPROM, EPROM, flash memory devices, magnetic disks, etc., and combinations thereof. The memory 1054 can store data 1056 and instructions 1058 which are executed by the processor 1052 to cause the training computing system 1050 to perform operations. In some implementations, the training computing system 1050 includes or is otherwise implemented by one or more server computing devices.

The training computing system 1050 can include a model trainer 1060 that trains a machine-learned model stored at the user computing device 1002 and/or the server computing system 1030 using various training or learning techniques, such as, for example, backwards propagation of errors. In other examples as described herein, training computing system 1050 can train a machine-learned model prior to deployment for provisioning of the machine-learned model at user computing device 1002 or server computing system 1030. The machine-learned model can be stored at training computing system 1050 for training and then deployed to user computing device 1002 and server computing system 1030. In some implementations, performing backwards propagation of errors can include performing truncated backpropagation through time. The model trainer 1060 can perform a number of generalization techniques (e.g., weight decays, dropouts, etc.) to improve the generalization capability of the models being trained.

In particular, the model trainer 1060 can train the machine learned models 1020 and 1040 based on a set of training data 1062. The training data 1062 can include, for example, a plurality of instances of sensor data, where each instance of sensor data has been labeled with ground truth inferences such as indications of motion complexity, motion intensity, motion skill, etc. For example, the label(s) for each training data can describe the position and/or movement (e.g., velocity or acceleration) of a touch input or an object movement. In some implementations, the labels can be manually applied to the training data by humans. In some implementations, the models can be trained using a loss function that measures a difference between a predicted inference and a ground-truth inference. In some implementations, the models can be trained using a combined loss function. The total loss can be backpropagated through the model.

In some implementations, if the user has provided consent, the training examples can be provided by the user computing device 1002. Thus, in such implementations, the machine learned model 1020 provided to the user computing device 1002 can be trained by the training computing system 1050 on user-specific data received from the user computing device 1002. In some instances, this process can be referred to as personalizing the model.

The model trainer 1060 includes computer logic utilized to provide desired functionality. The model trainer 1060 can be implemented in hardware, firmware, and/or software controlling a general purpose processor. For example, in some implementations, the model trainer 160 includes program files stored on a storage device, loaded into a memory and executed by one or more processors. In other implementations, the model trainer 1060 includes one or more sets of computer-executable instructions that are stored in a tangible computer-readable storage medium such as RAM hard disk or optical or magnetic media.

The network 1080 can be any type of communications network, such as a local area network (e.g., intranet), wide area network (e.g., Internet), or some combination thereof and can include any number of wired or wireless links. In general, communication over the network 1080 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

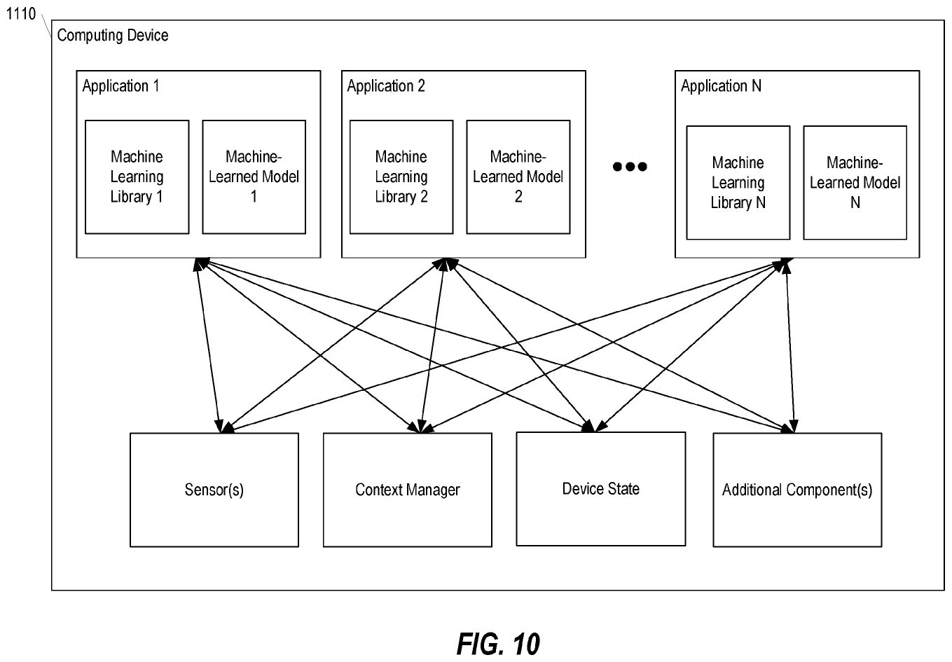

FIG. 10 illustrates one example computing system that can be used to implement the present disclosure. Other computing systems can be used as well. For example, in some implementations, the user computing device 1002 can include the model trainer 1060 and the training data 1062. In such implementations, the machine learned model 1020 can be both trained and used locally at the user computing device 1002. In some of such implementations, the user computing device 1002 can implement the model trainer 1060 to personalize the machine learned model 1020 based on user-specific data.

FIG. 10 depicts a block diagram of an example computing device 1110 that performs according to example embodiments of the present disclosure. The computing device 1110 can be a user computing device or a server computing device.

The computing device 1110 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 10, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

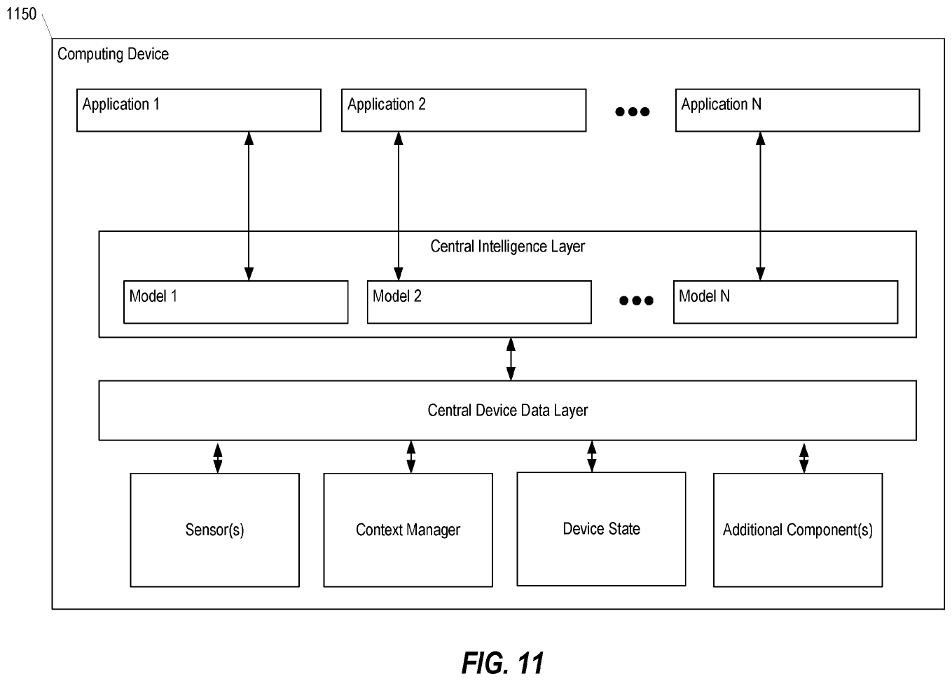

FIG. 11 depicts a block diagram of an example computing device 1150 that performs according to example embodiments of the present disclosure. The computing device 1150 can be a user computing device or a server computing device.

The computing device 1150 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 11, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 1150.

The central intelligence layer can communicate with a central device data layer. The central device data layer can be a centralized repository of data for the computing device 1150. As illustrated in FIG. 11, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computing system, comprising:
one or more processors; and
one or more non-transitory computer-readable media that collectively store instructions that when executed by the one or more processors cause the one or more processors to perform operations, the operations comprising:
obtaining sensor data associated with one or more sensors of a wearable device;
inputting the sensor data into one or more machine-learned models that have been trained, based at least in part on one or more target criteria, to determine a position of the sensor data within a continuous embedding space;
obtaining as an output of the one or more machine-learned models, data indicative of the position of the sensor data within the continuous embedding space;
determining a functionality associated with the position of the sensor data within the continuous embedding space; and
initiating the functionality associated with the position of the sensor data within the continuous embedding space.

2. The computing system of claim 1, wherein the one or more machine-learned models are configured to:
receive the sensor data associated with the one or more sensors of the wearable device;
project the sensor data into the continuous embedding space;
determine the position of the sensor data within the continuous embedding space based on projecting the sensor data; and
provide the data indicative of the position of the sensor data within the continuous embedding space as the output of the one or more machine-learned models.

3. The computing system of claim 1, wherein:
the one or more target criteria are associated with one or more motion categorizations; and
the data indicative of the position of the sensor data within the continuous embedding space comprises data indicative of a level of the sensor data within the one or more motion categorizations.

4. The computing system of claim 1, wherein:
the data indicative of the position of the sensor data within the continuous embedding space comprises data indicative of a motion signature associated with the sensor data.

5. The computing system of claim 1, wherein the operations further comprise:
obtaining data indicative of a motion signature in the continuous embedding space, the motion signature being generated in response to sensor data associated with one or more sensors of a second wearable device.

6. The computing system of claim 5, wherein the operations further comprise:
comparing the position of the sensor data within the continuous embedding space to the motion signature in the continuous embedding space to generate one or more comparison results; and
wherein determining the functionality associated with the position of the sensor data within the continuous embedding space comprises determining the functionality based at least in part on the one or more comparison results.

7. The computing system of claim 1, wherein:
the one or more machine-learned models are associated with a gaming application executing on computing device that is separate and distinct from the wearable device; and
initiating, by the one or more processors, the functionality associated with the position of the sensor data within the continuous embedding space comprises initiating the functionality within the gaming application based on the data indicative of the position of the sensor data within the continuous embedding space.

8. A computer-implemented method for discovery of undefined user movements, comprising:
obtaining, by one or more processors, sensor data associated with one or more sensors of a wearable device;
inputting, by the one or more processors, the sensor data into one or more machine-learned models that have been trained, based at least in part on one or more target criteria, to determine a position of the sensor data within a continuous embedding space;
obtaining, by the one or more processors, as an output of the one or more machine-learned models, data indicative of the position of the sensor data within the continuous embedding space;
determining, by the one or more processors, a functionality associated with the position of the sensor data within the continuous embedding space; and
initiating, by the one or more processors, the functionality associated with the position of the sensor data within the continuous embedding space.

9. The computer-implemented method of claim 8, wherein the one or more machine-learned models are configured to:
receive the sensor data associated with the one or more sensors of the wearable device;
project the sensor data into the continuous embedding space;
determine the position of the sensor data within the continuous embedding space based on projecting the sensor data; and
provide the data indicative of the position of the sensor data within the continuous embedding space as the output of the one or more machine-learned models.

10. The computer-implemented method of claim 8, wherein:
the one or more target criteria are associated with one or more motion categorizations; and
the data indicative of the position of the sensor data within the continuous embedding space comprises data indicative of a level of the sensor data within the one or more motion categorizations.

11. The computer-implemented method of claim 8, wherein:
the data indicative of the position of the sensor data within the continuous embedding space comprises data indicative of a motion signature associated with the sensor data.

12. The computer-implemented method of claim 8, further comprising:
obtaining, by the one or more processors, data indicative of a motion signature in the continuous embedding space, the motion signature being generated in response to sensor data associated with one or more sensors of a second wearable device.

13. The computer-implemented method of claim 12, further comprising:
comparing the position of the sensor data within the continuous embedding space to the motion signature in the continuous embedding space to generate one or more comparison results; and
wherein determining the functionality associated with the position of the sensor data within the continuous embedding space comprises determining the functionality based at least in part on the one or more comparison results.

14. The computer-implemented method of claim 8, wherein:
the one or more machine-learned models are associated with a gaming application executing on computing device that is separate and distinct from the wearable device; and
initiating, by the one or more processors, the functionality associated with the position of the sensor data within the continuous embedding space comprises initiating the functionality within the gaming application based on the data indicative of the position of the sensor data within the continuous embedding space.

15. One or more non-transitory computer-readable media storing computer instructions, that when executed by one or more processors, cause the one or more processors to perform operations, the operations comprising:
obtaining data descriptive of one or more machine-learned models;
obtaining data descriptive of one or more target criteria for a continuous embedding space of the one or more machine-learned models;
providing one or more sets of training data as input to the one or more machine-learned models;
obtaining, as output of the one or more machine-learned models, data indicative of a position of the one or more sets of training data within the continuous embedding space;
determining one or more loss function parameters based at least in part of the one or more target criteria and the data indicative of the position of the one or more sets of training data within the continuous embedding space; and
modifying at least a portion of the one or more machine-learned models based at least in part on the one or more loss function parameters.

16. The one or more non-transitory computer-readable media of claim 15, wherein:
the one or more target criteria are representative of one or more motion categorizations.

17. The one or more non-transitory computer-readable media of claim 15, wherein:
the one or more machine-learned models are configured to generate, in response to input data, a level for the input data for each of the one or more motion categorizations.

18. The one or more non-transitory computer-readable media of claim 15, wherein:
the one or more sets of training data include a positive training data set comprising sensor data annotated to indicate a high level of at least one of motion complexity, motion intensity, or motion skill; and
the one or more sets of training data include a negative training data set comprising sensor data annotated to indicate a low level of at least one of motion complexity, motion intensity, or motion skill.

19. The one or more non-transitory computer-readable media of claim 18, wherein:
the one or more machine-learned models are configured for deployment by a wearable device.

20. The one or more non-transitory computer-readable media of claim 19, wherein:
the one or more machine-learned models are associated with a health monitoring application executable by a computing device that is separate and distinct from the wearable device; and
initiating, by the one or more processors, the functionality associated with the position of the sensor data within the continuous embedding space comprises initiating the functionality within the health monitoring application based on the data indicative of the position of the sensor data within the continuous embedding space.
